(19) United States
(12) Patent Application Publication
(10) Pub. No.: US 2018/0285799 A1
(43) Pub. Date: Oct. 4, 2018

(54) AUTOMATED GOODS-RECEIVED NOTE GENERATOR

(71) Applicant: INTERNATIONAL BUSINESS MACHINES CORPORATION, ARMONK, NY (US)

(72) Inventors: SHELLEY DAVIES, LONDON (GB); CHITRA DORAI, CHAPPAQUA, NY (US); YING LI, MOHEGAN LAKE, NY (US); MUTHU M. MUTHIAH, BENGALURU (IN)

(21) Appl. No.: 15/470,966

(22) Filed: Mar. 28, 2017

(51) Int. Cl. G06Q 10/06; G06Q 10/08

(52) U.S. Cl. CPC G06Q 10/06313; G06Q 10/083

(57) ABSTRACT

In response to receiving notice of receipt of a shipment of goods with an associated shipping document, aspects drive a camera to acquire a digital image of the shipping document; acquire comments from a receiver of the goods as to a satisfactory quality of the received goods; extract structured text content from the image of the shipping document and from the acquired receiver comments that is relevant to generating a goods-received note; and automatically generate a goods-received note from the extracted text content of the image of the shipping document and from the extracted structured text content to include quantity of goods satisfactorily received.

### BACKGROUND

Enterprise resource planning (ERP) refers to processes and system utilized by an organization or commercial company to manage and integrate important parts of its business activities. An ERP management information system integrates areas such as planning, purchasing, inventory, sales, marketing, finance and human resources. Procure to Pay (P2P) processes and systems refer to systems and mechanisms for requesting (requisitioning), purchasing, receiving, paying for and accounting for goods and services. ERP systems connect these processes, enabling increased financial and procurement visibility, efficiency, cost savings and control.

In response to a request for goods or service, procurement teams follow standardized operating procedures of the ERP or P2P to identify vendors, evaluate terms, get different quotes from the identified vendors, approve one or more relatively best offers and make an associated purchase requisition, via generating and sending an appropriate Purchase Order (PO) to a supplier. Such purchase orders are generally updated in ERP processes in response to a variety of inputs and actions, including in response to notifications that a supplier has received a purchase order and shipped associated goods to the requesting company or other entity designated in the PO. In response to receiving the goods (by a warehouse, receiving office, etc.), the receiving entity of the requesting company generally creates or submits a “goods received note” (GRN) that meets the requirement of the ERP system and based on receipt of the goods. Once goods are shipped, a supplier may generally submit an invoice to the requesting company, which will be recorded into its ERP by the Accounts Payable team. Payment of the invoice is dependent upon a 3-way matching, i.e. the matching of the invoice, PO and the GRN indicating that the goods have been satisfactorily accepted as ordered by the purchasing entity or representative or agent thereof.

### SUMMARY

In one aspect of the present invention, a computerized method for the automated generation of a goods-received note upon reception of goods includes executing steps on a computer processor. Thus, a computer processor is configured to, in response to receiving notice of receipt of a shipment of goods with an associated shipping document, drive a camera to acquire a digital image of the shipping document; acquire comments from a receiver of the goods as to a satisfactory quality of the received goods; extract structured text content from the image of the shipping document and from the acquired receiver comments that is relevant to generating a goods-received note; and automatically generate a goods-received note from the extracted text content of the image of the shipping document and from the extracted structured text content to include quantity of goods satisfactorily received.

In another aspect, a system has a hardware processor in circuit communication with a computer readable memory and a computer-readable storage medium having program instructions stored thereon. The processor executes the program instructions stored on the computer-readable storage medium via the computer readable memory and is thereby configured to, in response to receiving notice of receipt of a shipment of goods with an associated shipping document, drive a camera to acquire a digital image of the shipping document; acquire comments from a receiver of the goods as to a satisfactory quality of the received goods; extract structured text content from the image of the shipping document and from the acquired receiver comments that is relevant to generating a goods-received note; and automatically generate a goods-received note from the extracted text content of the image of the shipping document and from the extracted structured text content to include quantity of goods satisfactorily received.

In another aspect, a computer program product for the automated generation of a goods-received note upon reception of goods has a computer-readable storage medium with computer readable program code embodied therewith. The computer readable hardware medium is not a transitory signal per se. The computer readable program code includes instructions for execution which cause the processor to, in response to receiving notice of receipt of a shipment of goods with an associated shipping document, drive a camera to acquire a digital image of the shipping document; acquire comments from a receiver of the goods as to a satisfactory quality of the received goods; extract structured text content from the image of the shipping document and from the acquired receiver comments that is relevant to generating a goods-received note; and automatically generate a goods-received note from the extracted text content of the image of the shipping document and from the extracted structured text content to include quantity of goods satisfactorily received.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 is a flow chart illustration of an embodiment of the present invention.

FIG. 5 is a block diagram illustration of an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

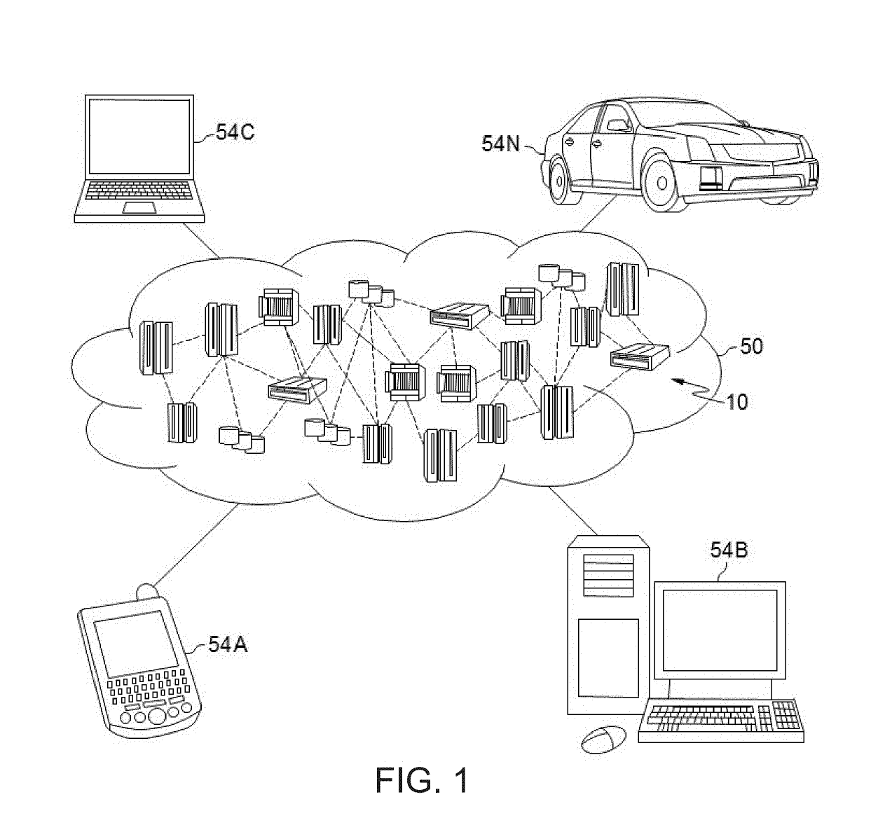

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

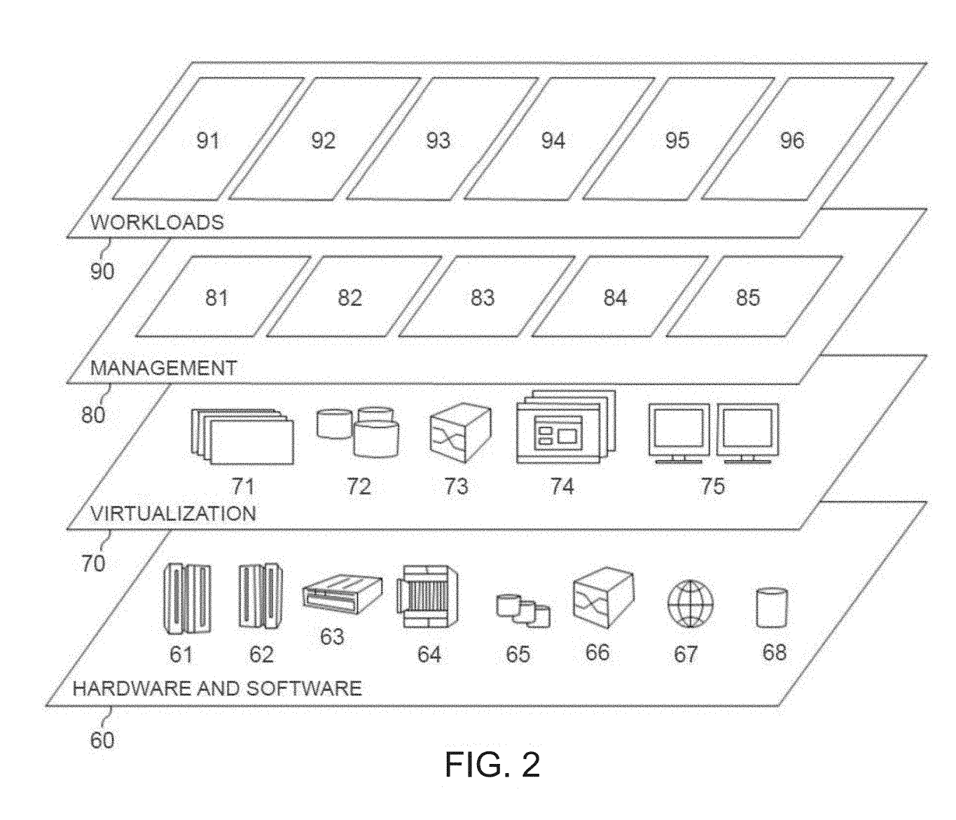

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for the automated generation goods received note upon reception of goods 96 according to aspects of the present invention as described below.

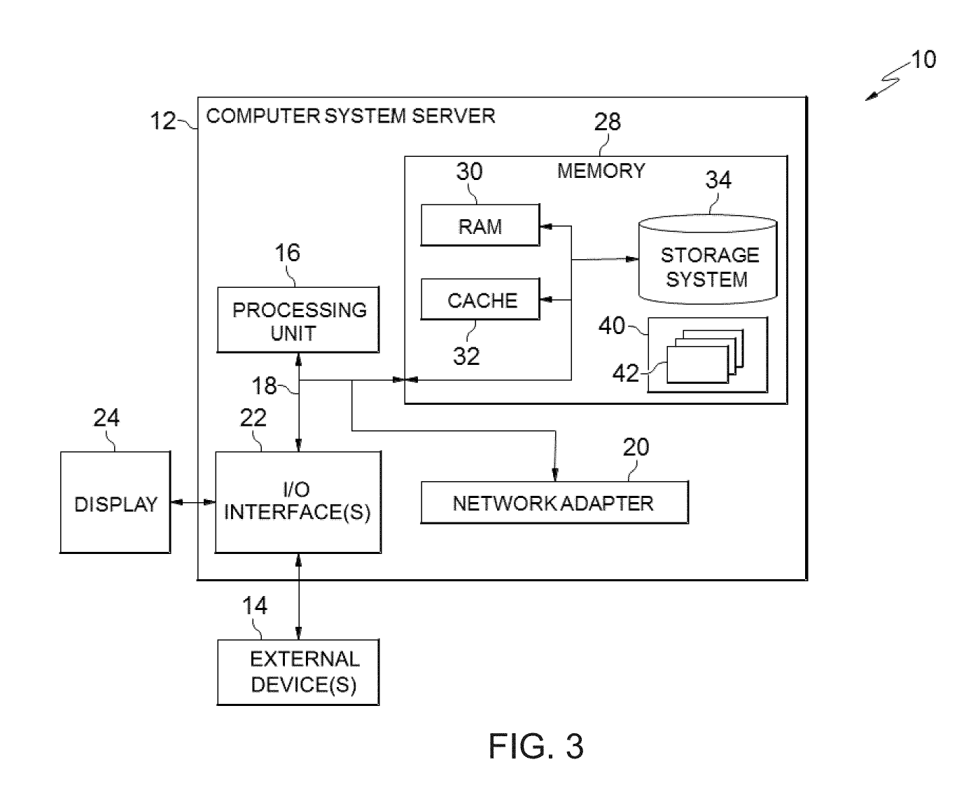

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

ERP systems may include three-way matching processes to authorize payment of an invoice, requiring a match between a PO, a GRN and the invoice documents prior to authorizing and making payments to satisfy a given vendor invoice. However, delays in generating or identifying documents may result in mismatches or other problems in satisfying three-way matching requirements. For example, an invoice may arrive within an ERP intake entity before a GRN has been entered into the system or is otherwise available to the ERP intake entity.

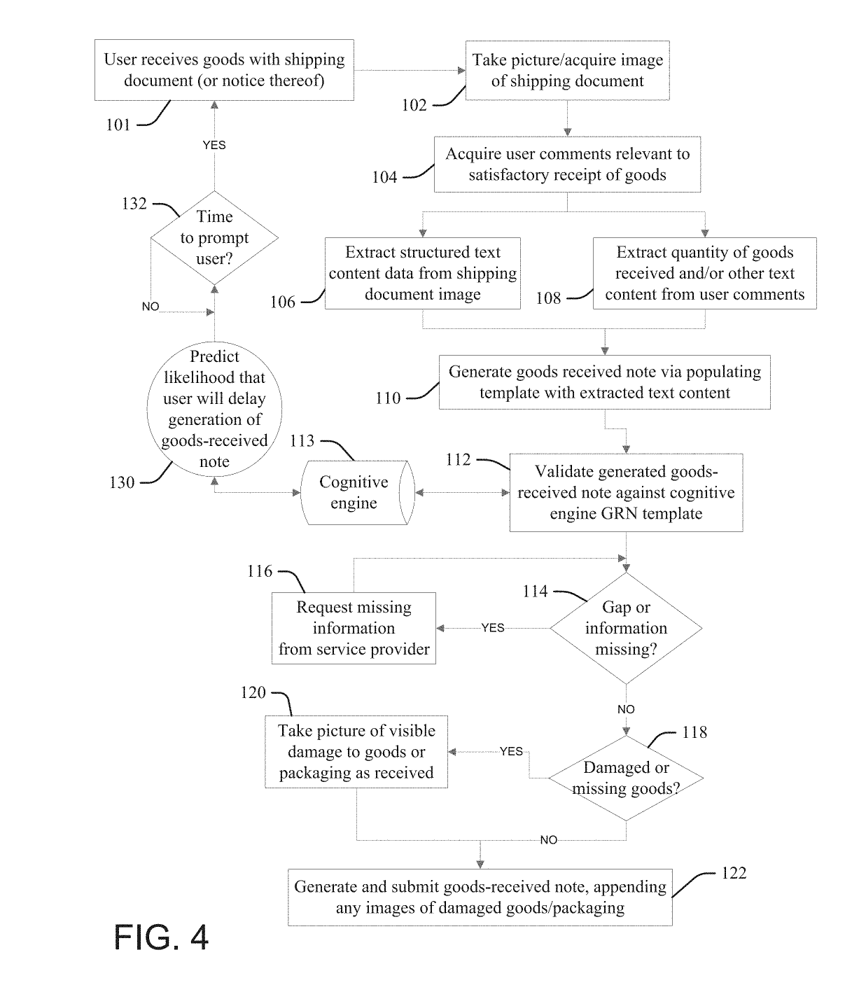

FIG. 4 illustrates a process or system according to the present invention for the automated generation of a goods-received note upon reception of goods. At 101 a user (e.g. a warehouse owner) receives a shipment of goods with an associated shipping document (generally a printed, tangible publication thereof) that comprises text information relevant to the shipped goods. Illustrative but not limiting or exhaustive examples of the shipping document include an air waybill, bill of lading, truck bill of lading, commercial invoice, certificate of origin, insurance certificate, packing list, shipping label, and still other documents used to ship, clear customs and take delivery of the goods may function as the shipping document.

At 102 a processor of a mobile device operated by the receiving user that is configured by executing a GRN generation mobile application according to an aspect of the present invention (the “configured processor”) takes a picture or otherwise acquires an image of the printed, tangible shipping document, to generate a digital image file representation thereof. Generally, the mobile device is a smart phone or tablet or other personal programmable device of a person receiving the goods, wherein the receiving user initiate execution of the GRN generation mobile application and thereby causes the configured processor to drive a camera of the mobile device to take a picture of a shipping document or otherwise acquire an image of the printed, tangible shipping document at 102. In some embodiments, the configured processor causes a scanner that is in communication with the mobile device at 102 to scan a paper shipping document, or it otherwise acquires from the scanner a digital image copy of the shipping document that is generated by the scanner.

In some embodiments of the present invention the configured processor receives the shipping document or generates the shipping document at 102 from a radio frequency identification (RFID) file or data stream broadcast from a RFID tag located on the goods or packaging thereof, via an appropriate sensor or reception device in communication with an RFID reader application executing on the configured processor; or via some other digital communication link to broadcast data (WiFi, BLUETOOTH, etc.). In such examples acquisition of the shipping document data by the configured processor may omit the steps of acquiring a digital image of a tangible printout of the shipping document. Still other examples of shipping document data acquisition at 102 will be appreciated by one skilled in the art, and the scope of the present invention is not limited to the illustrative but not limiting or exhaustive examples provided herein.

At 104 the configured processor acquires an input of comments or notes from the user of the mobile device that are relevant to the satisfactory receipt of the goods with the shipping document image. Said comments may be defined in terms of satisfaction of an originating purchase order. The configured processor may be implemented in accordance with the computer system server 10 of FIG. 3, including as the cloud node 10 of FIG. 1, as described respectively above.

Generally, the user comments comprise or convey (or may be transformed into) text content, via direct text content input or selection of radio buttons or other predefined choices that are associated with different respective text content (for example, selecting a bubble next to a number of items received). Illustrative but not limiting or exhaustive examples of the text content directly or inherently conveyed by the user's comment inputs include identity and quantity of goods received, condition of goods or shipping packaging upon receipt, and identity of receiver (facility location address, warehouse name, organization department, user name, and/or employee number, etc.).

In some embodiments, the configured processor executes an application at 104 that provides the user with a fillable graphical user interface (GUI) field on a display device of the mobile device, and wherein the user types in or uses a stylus to write in the receiver's text comment content. Embodiments may also prompt the user to speak comment content into a microphone of the mobile device, wherein the configured processor uses text-to-speech processing to transform the auditory, spoken content into text content.

In some examples the receiver's text comments are hand written onto the shipping document prior to acquiring the image thereof at 102, wherein the configured processor uses image analysis at 104 to identify and distinguish the hand-written notes from other content within the shipping document image.

At 106 the configured processor extracts or recognizes structured text content from the image of the shipping document that is relevant to generating a goods-received note, via optical character recognition (OCR) or other image analysis processes. (Wherein the shipping document text content is acquired from RFID or other non-tangible means, the OCR or other image analysis steps are omitted.) The structured text content is data that is relevant to (or required to) generate a goods-received note in satisfaction of a three-way matching process with respect to the shipping document and to purchase order data. Illustrative but not limiting or exhaustive examples of the extracted content include shipper or supplier identity, shipping date, destination location, invoice number, purchase order number, product code or name, order quantity, per-item and total cost, etc.

With respect to an image of the shipping document, extraction at 106 may comprise applying image analysis to the digital image content to recognize text content within the image content and extract goods-received note data items as a function of text labels or other content association. For example, in response to recognizing (parsing) the phrase “Purchase order” within the text content, the configured processor identifies a discrete alphanumeric string that is directly associated with the phrase as a unique purchase order identification. Phrase association may be based on proximity and language rules, for example, identifying an alphanumeric string as a unique purchase order identifier in response to determining that it is located immediately to the right of the “Purchase order” phrase and after a colon, and therefore modified by the phrase under the language rules of the shipping document. It may also be based on formatting of the document, for example, in response to determining that the text content is immediately below an identifying phrase in a column set off from other columns of information by formatting lines, or that it is within a box on a shipping document form with an identifying phrase. The configured processor may also pull data from predefined areas or fields of the shipping document in response to recognizing a pre-defined format of the document: for example, identifying a purchase order number alphanumeric string in response to location of the string within a labeled box, or located a specified distance from certain top and side borders or other reference markings within the document.

At 108 the configured processor extracts or recognizes structured text content from the user comments acquired at 104 to determine one or more of quantities of the goods received, satisfactory (good) condition status, receiver identity, goods identity, other quantities received in unsatisfactory condition, damage noted to the goods or shipping packaging, and still other information may be specified and extracted in response to user settings and preferences.

At 110 the configured processor generates a goods-received note via populating template for the goods received note with the data extracted at 106 and 108, and by determining other required data. For example, the configured processor may determine a time and date of reception of the goods from time stamp data on the acquired image of the goods, if not otherwise provided by the user comment text content, or by another intake process input (for example, a time stamp from a scanner located at a loading dock, mail room or other initial receiving intake area). The configured processor may also display the time/date so determined to the user and require the user to confirm the default date, wherein the user may override or correct the determined date or time.

The configured processor populates the quantity of goods received (those acceptable, in good or satisfactory condition) in the goods-received note at 110 as a function of comparing and harmonizing the extracted user comment content to/with the extracted shipping document content. For example, where the quantity of goods shipped extracted from the shipping document at 106 is 10 widgets, and the user comment text content extracted at 108 is “Received 10 widgets but one of them is damaged,” the configured processor compares the goods quantity information in the shipping document text content and the user comment text content reduces the total quantity received by the quantity of damaged goods to generate a goods-received note at 110 that indicates that only nine widgets were received in good condition (in compliance with the purchase order terms), and optionally flags this amount as inconsistent with the shipped quantity. Alternatively, the configured processor may generate the goods-received note at 110 to indicate that ten widgets were received, but that the receiver claims that one is unacceptable, generating a request for credit for the value of the unacceptable item.

At 112 the configured processor validates the goods-received note generated at 110 against a GRN template from a cognitive engine 113, comparing the content of the generated goods-received note to one or more fields of the GRN template that are required to generate a valid GRN.

In response to identifying any data gaps or missing information at 114, at 116 the configured processor prompts the user to request (or automatically requests) from a service provider the missing information to resolve the gap (for example, name of receiving user or location of receipt, date and time of receipt, item identification indicia, etc.). Thus, the process returns to 114 to determine the sufficiency of any information or data added.

Once determined at 114 that sufficient information is acquired to generate the goods-received note, at 118 the configured processor determines whether any goods are damaged or missing. The determination may be based on express indications within the extracted user comment text content, such as the presence of the terms “damage” or “missing” or their related forms and equivalent or similar terms within the content, or through recognizing certain phrases (“two widgets are damaged,” “have cracked lenses,” etc.), It may also be based on a mismatch between respective shipped and received quantities extracted from the shipping document and receiving user comments, wherein fewer items are received than are indicated as shipped. Still other determinations will be apparent to one skilled in the art.

In response to determining at 118 that goods are damaged or missing, at 120 the configured processor instructs the user to use (or automatically drives) the mobile device camera to take a picture of any visible damage to the goods or to the shipping packaging (for example, torn or opened, un-sealed boxes, broken straps, etc.)

Thus, at 122 the configured processor generates and submits the goods-received note with complete information for three-way matching to the invoice (which will generally be submitted by the supplier later) and to the appropriate purchase order, including appending any images of damage obtained by the user at 120 (thereby providing data to support mismatches between shipped and received and accepted goods quantities).

Aspects of the present invention also incorporate cognitive engine structures 130 that apply predictive analytics to identify warehouses, or other receiving users who are historically late in generating goods-received notes, or conditions impacting the shipment that are historically associated with late goods-received note generation, in order to proactively prompt or otherwise notify the users at 132 of the need to timely generate goods-received notes via the process of FIG. 4 in response to receiving goods (at 101). Thus, in response to predicting at 130 that an elapsed time between a time of the receipt of the shipment of goods with the associated shipping document (at 101), and a time of execution of the step of automatically generating the goods-received note (at 122) will exceed a threshold standard time (for example, will exceed expected or average or acceptable performance times), the cognitive engine will generate and send email, text or other notices or reminder to the user or other appropriate entity (receiving department, specific warehouse, etc.), for example in response to determining at 132 once an estimated delivery date (obtained from a purchase order retrieved from the cognitive engine or ERP) is drawing closer.

Aspects of the configured processor execute cognitive engine processes at 130 to build models to predict a likelihood that a user will delay generation and submission of a goods-received note in subsequent iterations of the process at 122 (for example, over a time elapsed from receipt of the goods or notice thereof at 101 that is in excess of specified thresholds times) based on the historical behavioral data of the user or user location (warehouse, office, department, etc.), including iterative outputs of goods-received note generation and submissions at 122; and further as a function of other data inputs or observations that impact the timely generation of the goods-received note.

More particularly, inputs to the modelling process at 130 may include features that are associated with a receiving entity that are determined to potentially affect goods-received note creation. Illustrative but not limiting or exhaustive examples of said inputs include determinations of type of goods (easy and quick to inspect and unload and incorporate into warehouse stocks; or instead likely to require careful and time-consuming inspection or unpacking procedures, wherein the user needs prompting at 132 to begin early processing of the goods), receiving facility location (easy and efficient shipper access, or prone to traffic or port delays and therefor indicative of early user prompting at 132 to begin processing of the goods), business cycle or season (peak, busy season, requiring additional processing time, vs. off-peak season), date (holiday or weekend delivery, indicating reminder prompt at 132 on first business day thereafter), weather conditions (send early delivery notification at 132 in anticipation of likelihood of delay in processing due to prediction of snow-covered roadways), facility status (new warehouse and modern receiving department infrastructure, versus older and inefficient facilities that indicate periodic follow-up reminders at 132 until goods-received note is generated); and still others will be apparent to one skilled in the art.

In order to generate output likelihoods or probabilities that a given receiving user or warehouse will be late in generating a goods received note submission at 122 for any given goods input or notice thereof at 101, aspects of the configured processor may use traditional machine learning approaches in modelling predictions at 130 (for example, logistic regression, support vector machine (SVM), decision tree structures, etc.); or deep learning processes where a relatively large amount of input data is available for processing (for example, big data cloud resource analytics).

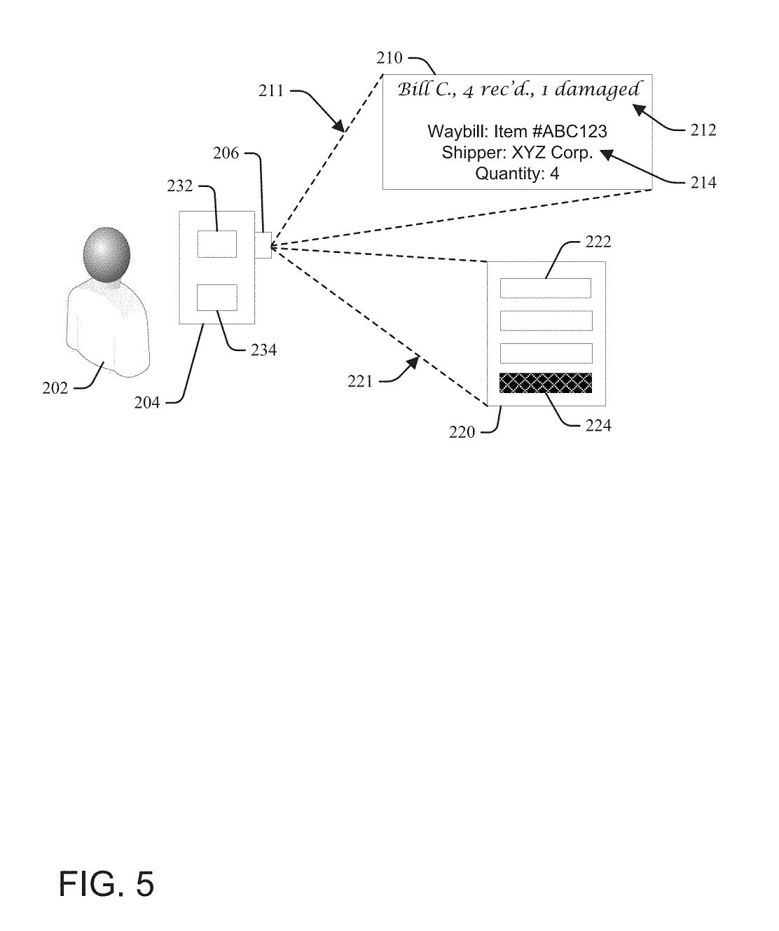

FIG. 5 illustrates one example implementation of an aspect of the present invention, wherein a user 202 receives a shipped container 220 of four goods 222, wherein one 224 is damaged, along with a printed shipping document (waybill) 210. The user 202 jots down on the waybill 210 comments 212 that include his identity as receiver (“Bill C.”) and the number of goods received and their status with respect to satisfactory delivery (“4 rec'd, 1 damaged”). The user 202 uses a camera component of the smart phone 204 to capture (via a focal view 211 of a camera lens 206 of the smart phone 204) a digital picture image 232 of the waybill 210 that comprehends the written comments 212 and shipping document text content 214 printed on the waybill 210. Thus, a processor within the smart phone 204 that is configured according to the present invention (the “configured processor”) executes process steps as illustrated in FIG. 4 and discussed above, including extracting structured text content via OCR processes from the user comments 212 (at 108, FIG. 4) and from the waybill (at 106, FIG. 4) to thereby generate a goods-received note that indicates a mismatch in the quantity of goods shipped to the quantity accepted in good condition (at 110, FIG. 4).

Thus, in response to determining that the user comments indicate damage to the goods (at 118, FIG. 4), the configured processor prompts the user 202 (at 120, FIG. 4) to acquire (via a focal view 221 of the camera lens 206) a digital picture image 234 of the damaged goods 224, which is attached to the generated goods-received note (at 122, FIG. 4).

Currently, enterprise resource planning systems attempt to resolve failures in three-way matching processes by holding received invoices and matched PO's in a pending status, and continually polling appropriate offices or document systems for arrivals of the matching GRN. However, these approaches create noise in the process and also delay vendor payments, leading to the generation of increased amounts of inquiries from unpaid vendors as to payment status, requiring the expenditure of resources in responding or otherwise processing each inquiry. Holding matched invoices and PO's in pending status may also result in the generation and submission of duplicate invoices by unpaid vendors, increasing exposure risk to double payment of invoices.

Delays in generating GRN's are commonly caused by delays by warehouse receiving personnel. In one exemplary study of Consumer Packaged Goods (CPG) industry practices, an average of 20% of open invoices were determined to be put on hold for missing GRN's, wherein 30% of associated invoices were paid at least 70 days late. Significant delays in receiving invoicing payments may result in a variety of actions by vendors and suppliers to the detriment of purchasing entities, including delaying the shipment or provision of future, additional goods or services until satisfaction of the outstanding invoices is received. Such delay may impact production of the receiver that is dependent upon the delayed supplies, causing corresponding negative impacts on product sales and revenue.

Aspects of the present invention apply cognitive and advanced analytics to assist warehouses and other receiving entities in reducing times required to accurately create and submit GRN's to appropriate purchasing departments, to thereby increase the likelihood of a timely three-way match of the GRN to the appropriate invoice and PO, relative to prior art systems and processes. Aspects leverage mobile programmable device capabilities to make it easier for a warehouse team to quickly capture and upload the status of received goods in association with their shipping documents (including invoices), via convenient mobile applications.

Aspects may be provided within executable applications (“apps”) on a user's smart phone, leveraging the camera and microphone of the smart phone to enable the user as receiver of goods to quickly and easily generate a goods-received note at the moment of reception of the goods. In some aspects the user merely jots down the number of goods received, and any damage impact on the goods, directly on a shipping slip, takes a picture of the slip with the notes thereon, and hits “enter”; wherein the configured processor does the rest of the work in the background (processing the unstructured data, and using any additional information acquired or uploaded from email queries to other entities as needed) to create the goods-received note, in a more timely and accurate fashion relative to prior art processes, without requiring further action on the part of the user.

Aspects provide advantages when deployed within “Procure to Pay” processes, (for example, autonomously acquiring data and determining (at 130, FIG. 4) “Perfect Order Index” metrics. Aspects also provide advantages when deployed within supply chain processes, for example, analyzing data to determine (at 130, FIG. 4) supplier metrics with regard to quality of service, how often goods are delivered correctly, and in good conditions, etc.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for the automated generation of a goods-received note upon reception of goods, comprising executing on a computer processor the steps of:
in response to receiving notice of receipt of a shipment of goods with an associated shipping document, driving a camera to acquire a digital image of the shipping document;
acquiring comments from a receiver of the goods as to a satisfactory quality of the received goods;
extracting structured text content from the image of the shipping document and from the acquired receiver comments that is relevant to generating a goods-received note; and
automatically generating a goods-received note from the extracted text content of the image of the shipping document and from the extracted structured text content to include a quantity of goods satisfactorily received.

2. The method of claim 1, further comprising:
comparing the extracted structured text content from the image of the shipping document to a template of goods-received note to identify a gap in information that is required to generate the goods-received note; and
in response to identifying the gap in information, requesting information that resolves the gap in the required information from a service provider; and
automatically generating the goods-received note in response to receiving the requested information that resolves the gap in the required information.

3. The method of claim 1, wherein the comments from the receiver of the goods as to the satisfactory quality of the received goods are text comments written on to the shipping document; and
wherein the step of acquiring the comments from the receiver of the goods as to the satisfactory quality of the received goods comprises obtaining the comments from the digital image of the shipping document via optical character recognition processing.

4. The method of claim 1, further comprising:
in response to determining that goods are damaged or missing within the received goods, driving the camera to take a picture of visible damage to the goods or to shipping packaging of the received goods; and
appending the picture of visible damage to the generated goods-received note.

5. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of driving the camera to acquire the digital image of the shipping document in response to receiving notice of receipt of the shipment of goods, acquiring the comments from the receiver of the goods as to the satisfactory quality of the received goods, extracting the structured text content from the image of the shipping document and from the acquired receiver comments relevant to generating the goods-received note, and automatically generating the goods-received note from the extracted text content of the image of the shipping document and from the extracted structured text content to include the quantity of goods satisfactorily received.

6. The method of claim 5, wherein the computer-readable program code is provided as a service in a cloud environment.

7. The method of claim 1, further comprising:
in response to predicting that an elapsed time between a time of the receipt of the shipment of goods with the associated shipping document, and a time of execution of the step of automatically generating the goods-received note will exceed a threshold standard time, prompting an initiating user to timely initiate the steps of driving the camera to acquire the digital image of the shipping document, acquiring the comments from the receiver of the goods as to the satisfactory quality of the received goods, extracting the structured text content from the image of the shipping document and from the acquired receiver comments and automatically generating the goods-received note.

8. The method of claim 7, further comprising:
predicting that the elapsed time between the time of the receipt of the shipment of goods with the associated shipping document and the time of execution of the step of automatically generating the goods-received note will exceed the threshold standard time as a function of historical behavioral data of the initiating user or of a location receiving the shipment of goods.

9. The method of claim 8, wherein the step of predicting that the elapsed time between the time of the receipt of the shipment of goods with the associated shipping document and the time of execution of the step of automatically generating the goods-received note will exceed the threshold standard time is further a function of attribute data that is selected from the group consisting of:
type of the shipped goods;
receiving facility location attributes;
relationship of a date of the receipt of the shipment of goods to period of time selected from the group consisting of a business cycle, a season, a holiday, and a weekend; and
a weather condition predicted for the date of the receipt of the shipment of goods.

10. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response to receiving notice of receipt of a shipment of goods with an associated shipping document, drives a camera to acquire a digital image of the shipping document;
acquires comments from a receiver of the goods as to a satisfactory quality of the received goods;
extracts structured text content from the image of the shipping document and from the acquired receiver comments that is relevant to generating a goods-received note; and
automatically generates a goods-received note from the extracted text content of the image of the shipping document and from the extracted structured text content to include quantity of goods satisfactorily received.

11. The system of claim 10, wherein the processor executes the program instructions stored on the computer-readable storage medium via the computer readable memory and thereby further:
compares the extracted structured text content from the image of the shipping document to a template of goods-received note to identify a gap in information that is required to generate the goods-received note; and
in response to identifying the gap in information, requests information that resolves the gap in the required information from a service provider; and
automatically generates the goods-received note in response to receiving the requested information that resolves the gap in the required information.

12. The system of claim 10, wherein the comments from the receiver of the goods as to the satisfactory quality of the received goods are text comments written on to the shipping document; and
wherein the processor executes the program instructions stored on the computer-readable storage medium via the computer readable memory and thereby acquires the comments from the receiver of the goods as to the satisfactory quality of the received goods by obtaining the comments from the digital image of the shipping document via optical character recognition processing.

13. The system of claim 10, wherein the processor executes the program instructions stored on the computer-readable storage medium via the computer readable memory and thereby further:
in response to determining that goods are damaged or missing within the received goods, drives the camera to take a picture of visible damage to the goods or to shipping packaging of the received goods; and
appends the picture of visible damage to the generated goods-received note.

14. The system of claim 10, wherein the processor executes the program instructions stored on the computer-readable storage medium via the computer readable memory and thereby further:
in response to predicting that an elapsed time between a time of the receipt of the shipment of goods with the associated shipping document and a time of automatically generating the goods-received note will exceed a threshold standard time, prompts an initiating user to initiate a timely driving of the camera to acquire the digital image of the shipping document, a timely acquisition of the comments from the receiver of the goods as to the satisfactory quality of the received goods, a timely extraction of the structured text content from the image of the shipping document and from the acquired receiver comments and a timely generation of the goods-received note.

15. The system of claim 14, wherein the processor executes the program instructions stored on the computer-readable storage medium via the computer readable memory and thereby further:
predicts that the elapsed time between the time of the receipt of the shipment of goods with the associated shipping document and the time of execution of the step of automatically generating the goods-received note will exceed the threshold standard time as a function of historical behavioral data of the initiating user or of a location receiving the shipment of goods.

16. A computer program product for the automated generation of a goods-received note upon reception of goods, the computer program product comprising:
a computer readable storage medium having computer readable program code embodied therewith, wherein the computer readable storage medium is not a transitory signal per se, the computer readable program code comprising instructions for execution by a processor that cause the processor to:
in response to receiving notice of receipt of a shipment of goods with an associated shipping document, drive a camera to acquire a digital image of the shipping document;
acquire comments from a receiver of the goods as to a satisfactory quality of the received goods;
extract structured text content from the image of the shipping document and from the acquired receiver comments that is relevant to generating a goods-received note; and
automatically generate a goods-received note from the extracted text content of the image of the shipping document and from the extracted structured text content to include quantity of goods satisfactorily received.

17. The computer program product of claim 16, wherein the computer readable program code instructions for execution by the processor further cause the processor to:
compare the extracted structured text content from the image of the shipping document to a template of goods-received note to identify a gap in information that is required to generate the goods-received note; and
in response to identifying the gap in information, request information that resolves the gap in the required information from a service provider; and
automatically generate the goods-received note in response to receiving the requested information that resolves the gap in the required information.

18. The computer program product of claim 16, wherein the comments from the receiver of the goods as to the satisfactory quality of the received goods are text comments written on to the shipping document; and
wherein the computer readable program code instructions for execution by the processor further cause the processor to acquire the comments from the receiver of the goods as to the satisfactory quality of the received goods by obtaining the comments from the digital image of the shipping document via optical character recognition processing.

19. The computer program product of claim 16, wherein the computer readable program code instructions for execution by the processor further cause the processor to:
in response to predicting that an elapsed time between a time of the receipt of the shipment of goods with the associated shipping document and a time of automatically generating the goods-received note will exceed a threshold standard time, prompt an initiating user to initiate a timely driving of the camera to acquire the digital image of the shipping document, a timely acquisition of the comments from the receiver of the goods as to the satisfactory quality of the received goods, a timely extraction of the structured text content from the image of the shipping document and from the acquired receiver comments and a timely generation of the goods-received note.

20. The computer program product of claim 19, wherein the computer readable program code instructions for execution by the processor further cause the processor to:
predict that the elapsed time between the time of the receipt of the shipment of goods with the associated shipping document and the time of execution of the step of automatically generating the goods-received note will exceed the threshold standard time as a function of historical behavioral data of the initiating user or of a location receiving the shipment of goods.
